(19) United States
(12) Patent Application Publication
(10) Pub. No.: US 2005/0262902 A1
(43) Pub. Date: Dec. 1, 2005

(54) Status indicator for a lock

(75) Inventors: Renny Tse-Haw Ling, Taipei Hsien (TW); Yung-Li Kuo, Taipei Hsien (TW)

Correspondence Address: APEX JURIS, PLLC, 13194 EDGEWATER LANE NORTHEAST, SEATTLE, WA, 98125, US

(73) Assignee: Sinox Co., Ltd., Chung-Ho City (TW)

(21) Appl. No.: 11/040,237

(22) Filed: Jan. 21, 2005

(30) Foreign Application Priority Data
May 27, 2004 (TW) 93115070

(51) Int. Cl. E05B 37/02; E05B 41/00

(52) U.S. Cl. 70/21; 70/25; 70/432

(57) ABSTRACT

A status indicator for a lock includes two locking units that operate independently, to execute locking and unlocking operations. The lock has a body, which contains an indicator and a brake bolt. The indicator is latched by the brake bolt to remain at a selected indication position. When one locking unit executes the unlocking operation, the indicator is driven concurrently to switch to another indication position corresponding to a window, and is latched by the brake bolt without returning. The brake bolt can only release the latch condition on the indicator through the unlocking operation of another locking unit. Likewise, the indicator returns to the original indication position. Thus through the window formed on the body surface, the indication position of the indicator may be recognized.

### FIELD OF THE INVENTION

The invention relates to a status indicator for a lock adopted for use on padlocks, locking devices or structural objects and particularly to a lock that has two locking units that function independently to execute locking and unlocking operations.

### BACKGROUND OF THE INVENTION

A lock is a widely used to guard articles that have obvious or potential security concern and to protect the articles. For instance, a padlock may be used to lock the zipper of luggage to prevent unauthorized opening.

Due to security concerns, nowadays airports have very strict standards for luggage inspection. To luggage having security concern, mandatory inspection of unfolding luggage could take place. For luggage that has been locked, the lock has to be broken. After inspection, the lock is damaged and not usable again. As a result, the damaged lock can no longer provide protection after the inspection has finished.

To remedy the problem of lock damage during security inspection, a lock equipped with two locking units has been developed. For instance, Travel Sentry™ Co. of U.S.A. introduces a number of locks for this purpose. They mainly have one set of locks to allow users to lock and unlock during use, and another set of locks for use during inspection. Hence the inspection people can perform routine security inspection through a normal unlocking procedure to open the lock, and close the lock after the inspection is finished. Therefore the lock may be prevented from damaging, and the luggage can have proper protection after inspection.

However, the locks mentioned above still have a drawback, namely after the security inspection of the luggage has finished and the lock is closed again, there is no indication to show that lock has been unlocked.

### SUMMARY OF THE INVENTION

In view of the aforesaid problem, the primary object of the present invention is to provide a lock that has two locking units functioning independently so that users can recognize which locking unit has been unlocked.

In order to achieve the foregoing object, the invention provides a status indicator for a lock with two locking units that has a window on the surface of a lock body and an indicator in the lock that has different indication positions switchable to the window once a locking unit has been unlocked, so that users can see the indicator through the window to identify the locking unit that has been unlocked.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention;

FIG. 2 is a plane view of the invention;

FIG. 3 is a fragmentary schematic view of an embodiment of the invention;

FIGS. 4 and 5 are schematic views of the invention in operating conditions;

FIG. 6 is a fragmentary perspective view of the invention;

FIGS. 7A and 7B are schematic views of the invention in operating conditions;

FIGS. 8A and 8B are fragmentary schematic views of embodiment variations and operating conditions of the invention;

FIG. 9 is an exploded view of another embodiment of the invention;

FIGS. 10A and 10B are schematic views of another embodiment of the invention in operating conditions;

FIGS. 11A and 11B are schematic views of another embodiment of the invention in operating conditions; and

FIG. 12 is a fragmentary schematic view of an embodiment variation of the invention.

### DESCRIPTION OF THE PREFERRED EMBODIMENTS

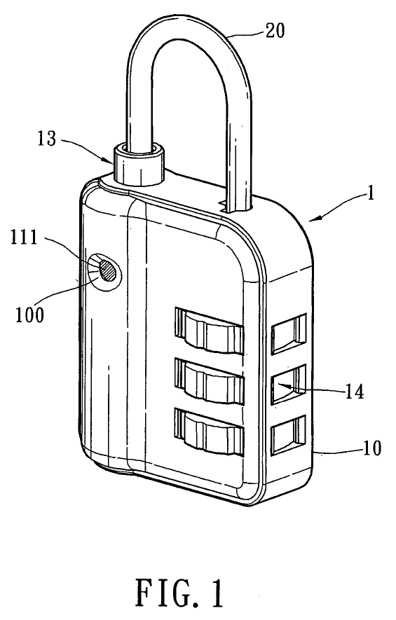

Referring to FIG. 1, the lock 1 according to the invention includes a body 10 and a shackle 20 for coupling a targeted object. The body 10 has a window 100 on the surface to indicate conditions.

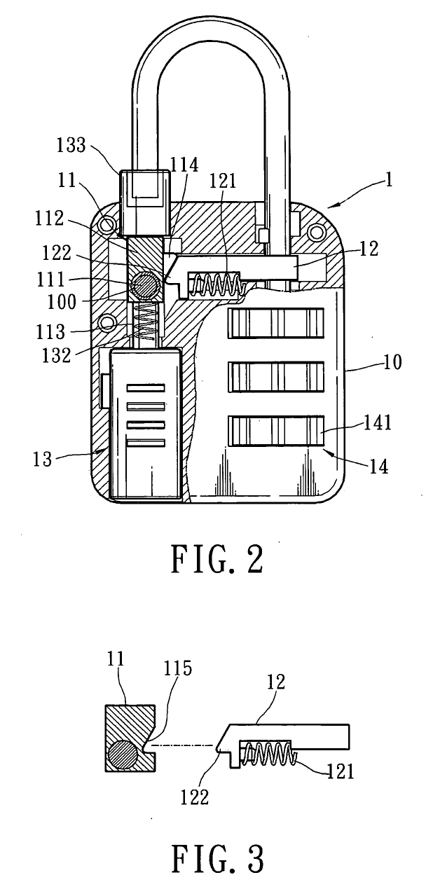

Referring to FIG. 2, the body 10 contains two locking units 13 and 14, an indicator 11 and a brake bolt 12. The two locking units are named a first locking unit 13 and a second locking unit 14 hereinafter to facilitate discussion.

The indicator 11 has one or more identified notations 111 and 112 that may be, but is not limited to, graphics, characters, color patches and combinations thereof that are distinguishable and may be differentiated visually. The identified notations may be formed on the indicator 11 by, but is not limited to, printing, carving, painting, sticking paper, and the like. In addition, the indicator 11 is coupled with a returning elastic element 113 (such as a compression spring) which has one end pressing the body 10, to allow the indicator 11 at a first indication position as shown in the drawing in normal condition.

The brake bolt 12 aims to generate a latch function. It is coupled with a ramming elastic element 121 which has one end pressing the body 10 to push the brake bolt 12 in contact with the indicator 11 in normal condition and latche the indicator 11.

As shown in the drawings, the brake bolt 12 has a one-way retaining section 122. The indicator 11 has a means mating the one-way retaining section 122, such as an extending sloped member 114, or a notch 115 shown in FIG. 3. Therefore, the one-way retaining section 122 can latch the sloped member 114 or notch 115 to anchor the indicator 11 on the first indication position.

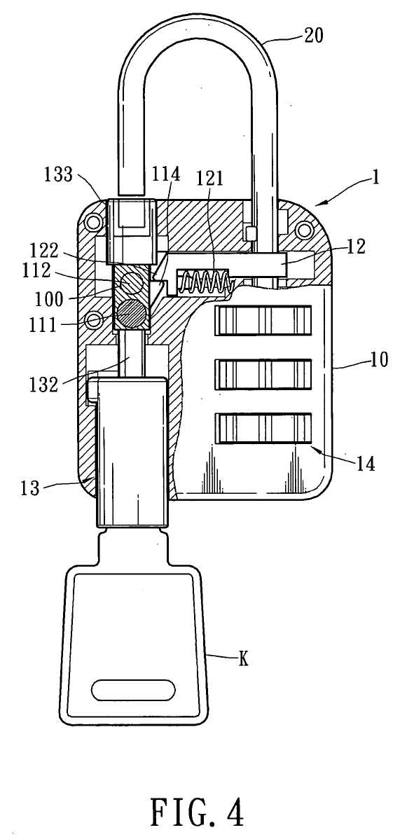

The first locking unit 13 is movable under operation. It has a locking position (referring to FIG. 2) relative to the body 10 and an unlocking position (referring to FIG. 4). The first locking unit 13 includes a cylinder 131, which has a concave head 133 extended from a shaft 132. Referring to FIG. 4, the locking state between the body 10 and the cylinder 131 may be released by inserting a key K into a key way of the cylinder 131, so that the cylinder 131 may be sunk axially, to disengage the turning restriction formed between the concave head 133 and the shackle 20. The shackle 20 may be turned outwards relative to the body 10 about another leg. In addition, while the cylinder 131 is moved, the concave head 133 is driven simultaneously to move the indicator 11 from the first indication position to a second indication position shown in the drawings. The brake bolt 12 retracts and returns again to form a latch condition with the indicator 11 to keep the indicator 11 at the anchor position. When the cylinder 131 is returned to the locking state through operation of the key K, the indicator 11 remains at the second indication position. Therefore, with the indicator 11 driven one-way by the first locking unit 13. Changing of the second identified notation 112 from the first identified notation 111 corresponding to the window 100 may recognize its position.

The second locking unit 14 may also be switched between an unlocking state and a locking state through operation. In this embodiment, the second locking unit 14 includes, but is not limited to, a combination lock, which has a dial wheel 141. The second locking unit 14 also can lock one leg of the shackle 20. The shackle 20 is inhibited from axial movement when the second locking unit 14 is in the locking state, and the shackle 20 has another leg extended in the concave head 133.

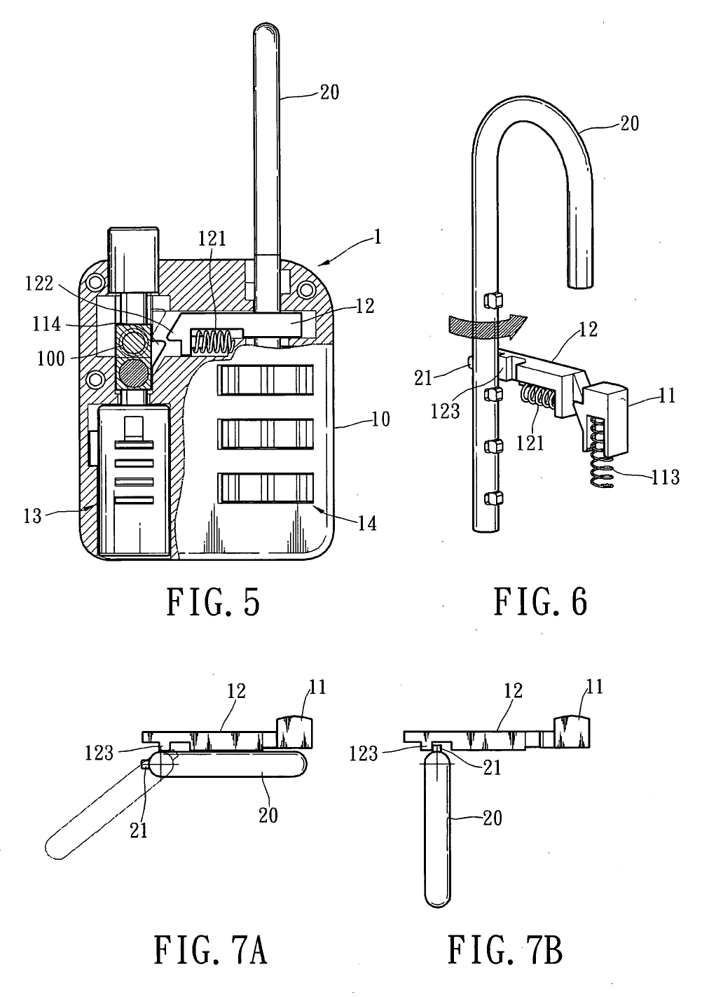

When the second locking unit 14 is switched to the unlocking state through operation, the shackle 20 is in the condition shown in FIG. 5, and moved axially relative to body 10 for a selected distance. During the axial movement, or by adding an extra operation, the brake bolt 12 is driven to release the latch condition on the indicator 11 so that the indicator 11 returns from the second indication position to the first indication position, and the notation corresponding to the window 100 is changed from the second identified notation 112 to the first identified notation 111.

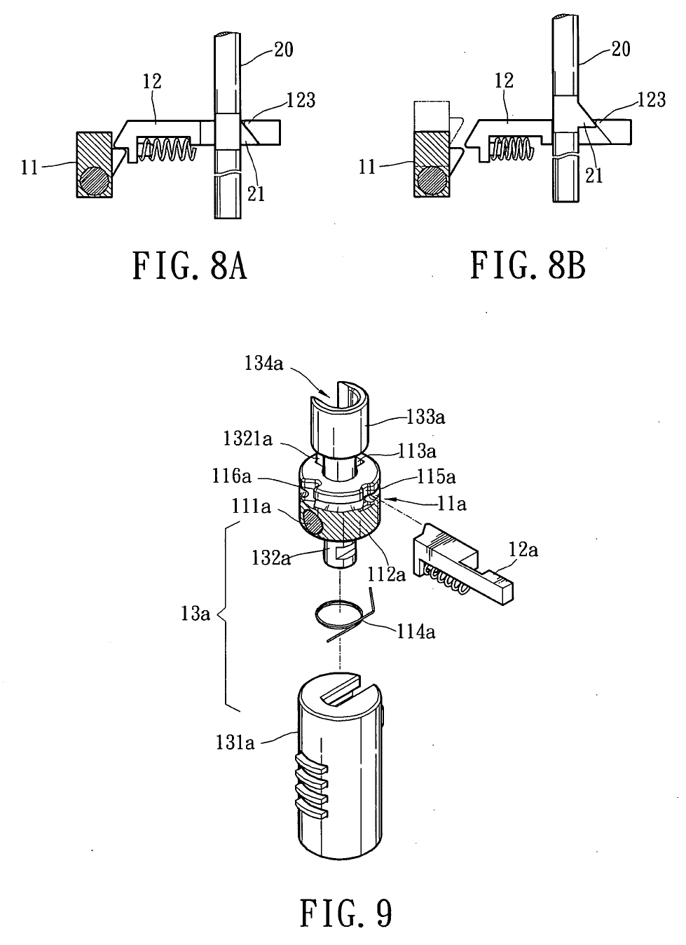

Refer to FIG. 6 for the brake bolt 12 releasing the latch condition on the indicator 11 after the shackle 20 has driven the brake bolt 12. The shackle 20 has a lug 21. When the second locking unit 14 has released the locking state on the shackle 20, the shackle 20 may be moved axially to release the turning restriction on the concave head 133. Referring to FIGS. 7 and 8, then the shackle 20 may be turned and the lug 21 pushes a bucking portion 123 on the brake bolt 12 to move the brake bolt 12 in a direction, to release the latch condition on the indicator 11.

Referring to FIGS. 8A and 8B, the lug 21 mates the bucking portion 123 in shape and position. While the shackle 20 is moved axially, the lug 21 pushes the bucking portion 123 on a sloped surface to release the latching of the brake bolt 12.

As previously discussed, while the indicator 11 has been moved to the second indication position through the latching of the brake bolt 12, the indicator 11 can return to the first indication position again only through the unlocking operation of the second locking unit 14. Hence by seeing different identified notations 111 and 112 through the window 100, a use condition of the lock may be recognized.

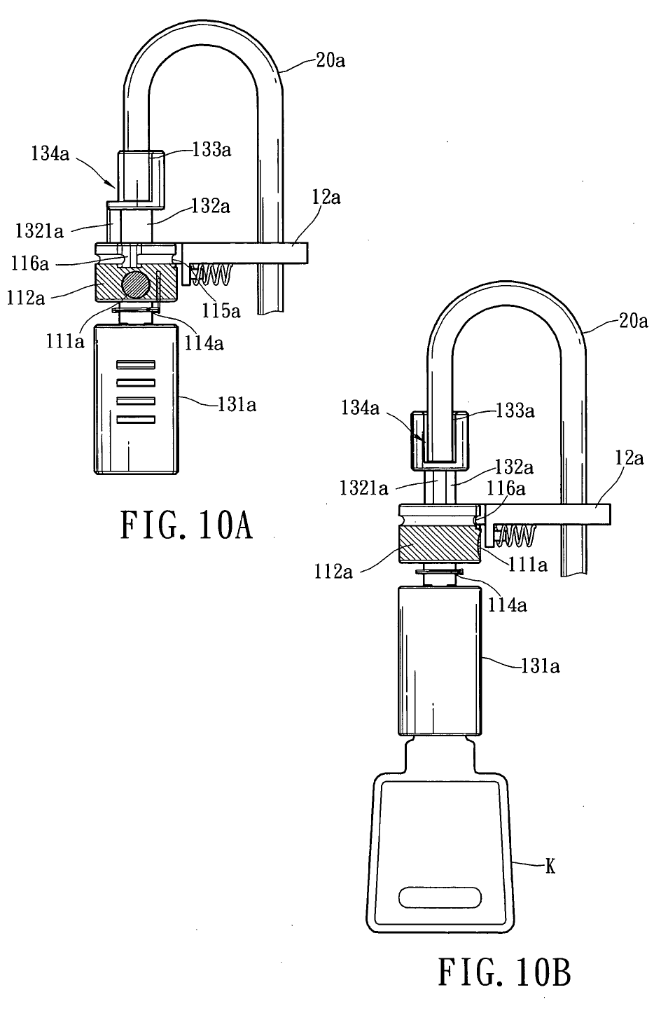

Refer to FIGS. 9, 10A and 10B for another embodiment of the invention. It differs from the previous embodiment, in which the indicator 11a is moved by turning to switch the first indication position and the second indication position.

The concave head 133a of the first locking unit 13a has a notch 134a, which enables the key K to drive the concave head 133a by turning the cylinder 131a so that the notch 134a may be switched to turn the shackle 20a at an unlocked position. Namely, the first locking unit 13a is moved to an unlocked position (referring to FIG. 1A) and locked position (referring to FIG. 19B) by turning.

As shown in the drawings, the indicator 11a has identified notations 111a and 112a, and a dial hole 113a in the axial direction, to enable the indicator 11a to run through the dial hole 113a and couple on the shaft 132a. Moreover, the indicator 11a is coupled with a returning elastic element 114a, which may be, but is not limited to, a torsion spring. In addition, the indicator 11a has a first latch notch 115a and a second latch notch 116a on the periphery, to engage with the brake bolt 12a when the indicator 11a is moved to the first indication position and the second indication position, to maintain the indicator 11a in a stationary condition.

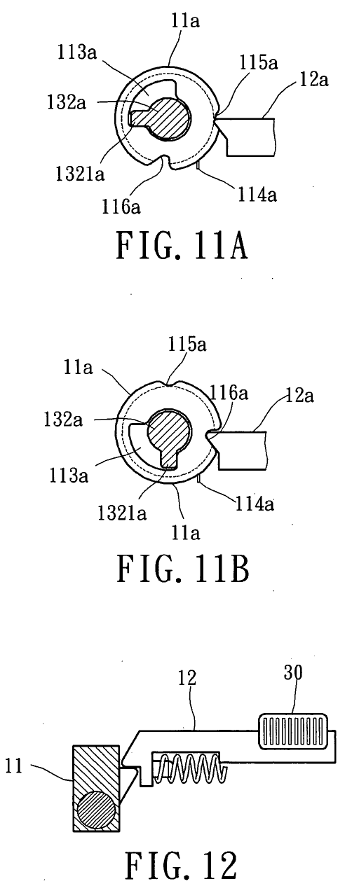

By means of the construction set forth above, when the first locking unit 13a is turned from a locked position shown in FIG. 11A to an unlocked position shown in FIG. 11B, the indicator 11a also is pushed by a picking bar 1321a, extended radially from the shaft 132a and moved from the first indication position to the second indication position. When the first locking unit 13a returns to the first indication position through operation, the indicator 11a still remains at the second indication position. The brake bolt 12a can only release the latch condition on the indicator 11a through the unlocking operation of the second locking unit 14. Likewise, the indicator 11a returns to the first indication position.

Refer to FIG. 12 for another latch operation of the brake bolt 12. Instead of driving the indicator 11 by the shackle 20 to release the latch condition, the brake bolt 12 is coupled with a brake knob 30 which may receive a force to drive the brake bolt 12 and release the latch condition on the indicator 11 and allow the indicator 11 to return to the first indication position.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

1. A status indicator for a lock comprising a body and a shackle coupled with the body from outside, the body having a window formed on the surface to indicate conditions, the body including:
an indicator marked with identified notations having a first indication position and a second indication position corresponding to the window, and coupling with a returning elastic element to maintain the indicator at the first indication position in a normal condition;
a brake bolt coupled with a ramming elastic element being in contact with the indicator in the normal condition to latch the indicator;
a first locking unit forming an unlocking position and a locking position relative to the body through operations, the indicator being driven concurrently when the first locking unit is moved from the locking position to the unlocking position so that the indicator is moved from the first indication position to the second indication position and latched by the brake bolt; and
a second locking unit switchable to the unlocking state and the locking state through operations, the brake bolt releasing the latch condition on the indicator in the unlocking state to allow the indicator to return from the second indication position to the first indication position.

2. The status indicator for a lock of claim 1, wherein the indicator switches the first indication position and the second indication position through a straight line movement.

3. The status indicator for a lock of claim 1, wherein the returning elastic element is a compression spring.

4. The status indicator for a lock of claim 1, wherein the brake bolt has a one-way retaining section in contact with the indicator, the one-way retaining section allowing the indicator to move one way from the first indication position towards the second indication position.

5. The status indicator for a lock of claim 1, wherein the indicator switches the first indication position and the second indication position through a turning path.

6. The status indicator for a lock of claim 1, wherein the returning elastic element is a torsional spring.

7. The status indicator for a lock of claim 1, wherein the indicator has a first latch notch and a second latch notch on the periphery to engage with the brake bolt when the indicator is located at the first indication position and the second indication position.

8. The status indicator for a lock of claim 1, wherein the shackle is locked by the second locking unit, the shackle being movable by a force to drive the brake bolt when the second locking unit is in the unlocking state so that the brake bolt releases the latch condition on the indicator.

9. The status indicator for a lock of claim 8, wherein the shackle has a lug to push the brake bolt and move the brake bolt in a direction to release the latch condition on the indicator.

10. The status indicator for a lock of claim 1, wherein the brake bolt is coupled with a brake knob which is movable by a force to drive the brake bolt to release the latch condition on the indicator and allow the indicator to return to the first indication position.

11. The status indicator for a lock of claim 1, wherein the identified notations are graphics.

12. The status indicator for a lock of claim 1, wherein the identified notations are characters.

13. The status indicator for a lock of claim 1, wherein the identified notations are color patches.
